(19) United States
(12) Patent Application Publication
(10) Pub. No.: US 2020/0398392 A1
(43) Pub. Date: Dec. 24, 2020

(54) APPARATUS FOR POSITIONING A WORKPIECE AND A TOOL WITH RESPECT TO ONE ANOTHER

(71) Applicant: Haux Maschinenbau GmbH, Stetten am Kalten Markt (DE)

(72) Inventor: Gühring Tilmann, Stetten am Kalten Markt (DE)

(21) Appl. No.: 16/968,463

(22) PCT Filed: Feb. 4, 2019
(86) PCT No.: PCT/DE2019/100116

§ 371 Date: Aug. 7, 2020

(30) Foreign Application Priority Data
Feb. 9, 2018 (DE) 10 2018 102 994.2

(51) Int. Cl. B23Q 3/18; B23K 37/04; B24B 41/06

(52) U.S. Cl. CPC B23Q 3/18; B24B 41/067; B23K 37/0452

(57) ABSTRACT

Rather than machine tools, nowadays robots are used to some extent for the machining of workpieces. The robot holds the tool and machines the workpiece directly. On account of the stiffness of the robot arm, this is currently possible only with imprecise applications with tolerances of not less than 0.1 mm. The invention is intended to make it possible to improve the feed by such robots or portal solutions such that the tolerances are reduced without substantially acting on the production processes. This is allowed by a table-mounted positioning apparatus, in which a positioning unit is connected to the table. The positioning unit has a position sleeve, into which the robot introduces an external holding device for receiving the workpiece, or for receiving the tool. On account of a defined mounting of the position sleeve about a first main axis of rotation about an inner holding device, which holds the tool, or the workpiece, improved positioning of the robot arm can be achieved by the additional support thus created. The positioning unit is in this case passive, i.e. is moved by the robot arm itself.

The present invention relates to an apparatus for positioning a workpiece and a tool with respect to one another, which are each held in a positioning apparatus, comprising an inner positioning apparatus arranged on a table as well as an external positioning apparatus arranged on a feed apparatus.

When a workpiece is machined, a workpiece must traditionally be brought into and held in an exact position with respect to a workpiece to be machined. Grinding machines used to machine tools, for example, or even machine tools, and generally all multi-axle machining apparatuses with components, drives and controls are subject to high requirements. Normally, the tool is introduced into the machine tool or its receiver and brought into engagement with the tool of the machine tool. This fixed introduction of the workpiece into the workpiece receiver makes it possible to machine said workpiece at that exact position. Such an apparatus and a respective machining method are known, for example, from WO 2001/66302 A1.

Further relevant prior art is found in DE 296 03 498 U1 and in DE 296 03 800 U1.

Since nowadays robots such as robotic or portal solutions with drives and controls of their own are used, their controls and actuators must be precisely positioned in this process. It is generally provided in this regard that the robot holds the tool and machines the workpiece directly. The reverse case is known for simple applications as well. On account of the stiffness of the robot arm, this is currently possible only with imprecise applications with tolerances of not less than 0.1 mm. Another known option is to firmly clamp the workpiece in place, which, however, requires a certain setup time and specific feeding equipment, which will generally exclusively feed the machine tool.

As a result, the present invention is based on the objective to propose an alternative machine concept, which combines functions of a machine tool and a robot and thus overcomes the disadvantages of prior art. According to this approach, an automation unit moves the axes of a stationary apparatus while the stationary apparatus fixes the automation unit in place.

Accordingly, an apparatus for positioning a workpiece and a tool with respect to one another according to the features of claim 1 achieves this objective. Expedient embodiments of this solution are described in the dependent claims below.

According to the invention, an apparatus for positioning a workpiece and a tool with respect to one another comprises an inner holding apparatus and an external holding apparatus. The inner holding apparatus is generally the one that is fastened to a table and thus remains stationary in its position. The external holding apparatus, however, is guided to the inner holding apparatus. In this regard, one holding apparatus can hold the workpiece, and the other holding apparatus can hold the tool. The intent is that both solutions are considered to be within the scope of the invention and protected.

The external holding apparatus is guided to the inner holding apparatus via a feed apparatus, which is preferably a portal solution or a robot arm. The problem here is, however, that a certain pressure that must be exerted can result in an imprecise position, for example when a workpiece held by the external holding apparatus is guided to the tool held by the inner holding apparatus. Since a certain feed direction may be specified for the feed apparatus and the tool counters said direction, the processing result may be imprecise. Due to the sheer length of the feed apparatus, the pressure against the tool results in counterpressure that the sensors of the feed apparatus cannot detect.

For this reason, the invention furthermore provides for a positioning unit, which comprises a position sleeve through which the external holding apparatus or the workpiece is introduced. Although the positioning unit is rotatably positioned about the inner holding apparatus so that it rotates about a first main axis of rotation, the pushing motion of the external holding apparatus caused by a fastening of the positioning unit on the same table can be reduced because the entire feed apparatus is no longer available, but instead only the tool up to the inner holding apparatus, which is accommodated in the position sleeve, is now available as a lever for pushing the feed apparatus away. The feed apparatus can simply introduce the external holding apparatus into this position sleeve. Consequently, a solution is created that combines the advantages of machine tool machining with the advantages of automation units.

In addition to a first degree of freedom provided by the rotatability of the position sleeve about a first main axis of rotation, the position sleeve may, in a further embodiment of the invention, be rotatably positioned about a first sleeve axis of rotation. This makes it possible to align the external holding apparatus at a skewed angle rather than exclusively with the first main axis of rotation. Using the example of a grinding machine, this makes it possible to not only machine the top of a workpiece guided there, for example a drill, but its sides as well.

This allows for a specific configuration of the positioning apparatus in which the position sleeve is arranged in a wall of an inner sliding ring, which slides in a concentrically arranged outer sliding ring along its inner surface. So as to be able to introduce the external holding apparatus into the position sleeve in spite of this two-layered ring, the outer sliding ring comprises, in this case, an elongated first opening so that the position sleeve remains accessible even in the event of a mutual turning of the sliding rings. As far as the position sleeve is to remain displaceable about its sleeve axis in this configuration, the position sleeve in the sliding ring is rotatably arranged on a pivotable mount so that a changeable angle can be achieved between the wall of the inner sliding ring and the position sleeve.

There are furthermore two different configurations with regard to the positioning of the inner holding apparatus. The inner holding apparatus may enter the two sliding rings from the bottom and therefore be vertically arranged. In that case, the inner holding apparatus is located approximately in the middle of the two sliding rings, depending on how far the inner holding apparatus is introduced. To make this possible, the inner sliding ring must comprise an elongated second opening through which a mount of the inner holding apparatus, which may be the machine tool itself, can extend. In the case of a grinding machine, the spindle would stand upright in this configuration, and a grinding disk would be aligned parallel to the table.

Alternatively, the position sleeve may also be rotatably positioned about the inner holding apparatus so as to be able to rotate about a second main axis of rotation. In this case, it would not be expedient for the machine tool to vertically extend into the sliding rings because, at least in cases where is workpiece is machined by rotating machining movement, the rotation position about a second main axis of rotation, which is preferably vertical to the table, is irrelevant. This is particularly advantageous when the inner holding apparatus protrudes into the sliding rings, i.e., their opening, either itself or if it holds the tool or the workpiece in this direction. To the extent the disclosure indicates that the holding direction is on the inside of the sliding rings, this must be understood to mean that they are located at least in the region of the ring opening such that the tool and the workpiece mutually engage with each other.

Such a rotation about the second main axis of rotation can, if it occurs vertical to the table, be realized by positioning the outer sliding ring on a turntable arranged on the table. This way, even in the case of a vertical arrangement of the inner holding direction and in case said arrangement comprises, for example, a vertically aligned grinding disk, a further degree of freedom between the workpiece and the tool is made possible.

In an alternative embodiment of the positioning unit, said unit may be configured as a slide solution that is arranged around the inner holding apparatus. In this case, a horizontal main axis of rotation can be dispensed with, and the first main axis of rotation is arranged vertically. To ensure that the inside of the arrangement can still be reached from different azimuthal angles, the position sleeve is additionally rotatably mounted about a second sleeve axis of rotation.

This can be achieved by accommodating the position sleeve on the inside of a carrier ring. By means of a rotatable connection to the carrier ring and a rotatable connection of the carrier ring to a slide, which is arranged vertically to said connection, the position sleeve becomes rotatable in two directions. The slide can, in this case, be moved on a guide track about the first main axis of rotation in a circular manner, in this case on a vertical axis of rotation. If necessary, a further degree of freedom may be obtained by additionally making the attachment of the carrier ring on the slide height adjustable.

As already mentioned, the feed apparatus may be designed as a robot arm. The positioning apparatus is advantageously passive and actuated by the movements of the robot arm as well after the external holding device has been introduced into the position sleeve. While the positioning apparatus can, in this case, perform the movement directions specified for said apparatus, it does not impair the existing degrees of freedom and once again provides support for the otherwise relatively long robot arm shortly in front of the counter piece.

This is the case accordingly when a portal solution is used as a feed apparatus. In this case, the external holding device is first positioned via three-dimensionally movable slides with the alignment of the outer holding apparatus being adjustable by at least one, preferably two angle degrees of freedom. After the exterior holding device has been introduced into the position sleeve, the positioning unit is moved here as well due to the pulling load of the portal solution and remains passive.

To the extent it is provided that the inner holding apparatus holds the tool, a supporting table may be arranged below the machine tool holding, in this case, the inner holding apparatus on which a fed workpiece can be supported once again by the feed apparatus. To this purpose, the supporting table may comprise a support sleeve, which may furthermore be suitable for introducing the workpiece at least partially. Furthermore, such a support sleeve may be connected to the supporting table in a height-adjustable manner so as to enable a more exact positioning.

Furthermore, and especially preferably, in the case of an inner holding apparatus connected to a machine tool, the tool may be designed as a grinding element or a milling element. Other known tool heads are possible as well.

If, however, the inner holding apparatus holds the workpiece, that means that the feed apparatus guides the tool. In this case, it is particularly advantageous if the external holding apparatus holds a tool laser with which the workpiece held in the inner holding apparatus is machined. In this case, the positioning apparatus holds the feed apparatus in an exact position.

To further increase the precision, individual or all axes of the positioning apparatus may be actively driven by actuators or other drives.

The invention described above is explained in further detail below on the basis of an exemplary embodiment.

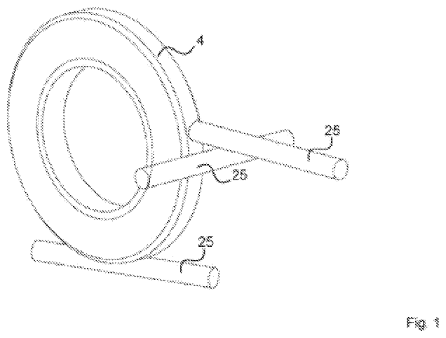

FIG. 1 shows a grinding element and three workpieces in different relative grinding positions in a perspective view,

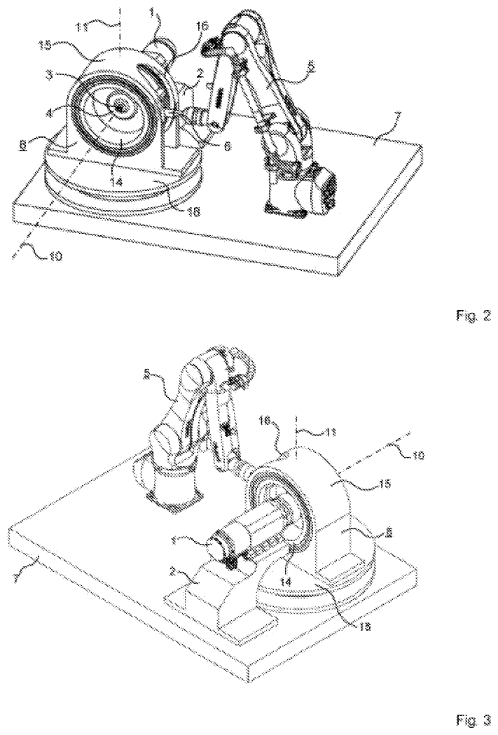

FIG. 2 shows a positioning apparatus with a robot arm as the feed apparatus and a horizontally arranged machine tool in an oblique frontal perspective view,

FIG. 3 shows the positioning apparatus according to FIG. 2 in an oblique rear perspective view,

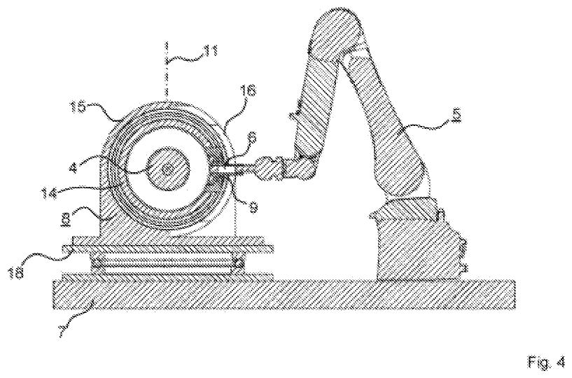

FIG. 4 shows the positioning apparatus according to FIG. 2 in a cross-sectional view through the center of the sliding rings,

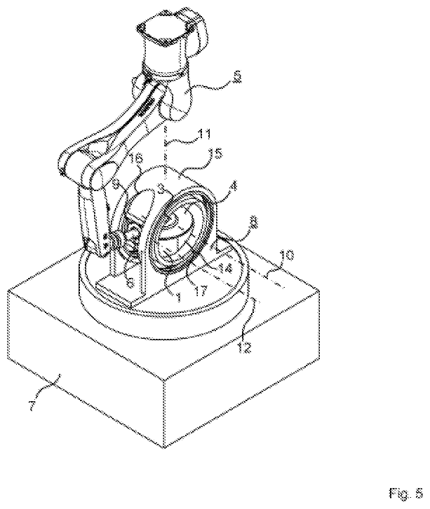

FIG. 5 shows an alternative positioning apparatus with a robot arm as the feed apparatus and a vertically arranged machine tool in an oblique top perspective view,

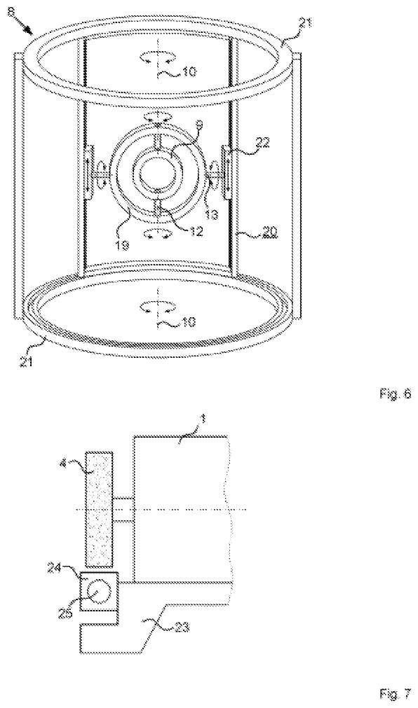

FIG. 6 shows a further alternative positioning apparatus with a position sleeve accommodated on a track-supported slide in an oblique top perspective view, and

FIG. 7 shows a supporting table below a horizontally arranged machine tool in a lateral top view.

FIG. 1 shows a grinding element 4 with which workpieces 25 can be machined, said machining serving, in this case, the production of tools. The workpieces 25 are drills, which must be machined in a plurality of positions. An arrangement in which the workpiece is vertically brought to the edge of the grinding element 4 is used to grind the tip of the drill. A positioning of the workpieces 25 transversely to the grinding element 4 or obliquely below the grinding element 4 serves to grind grooves and to machine the shaft. In traditional methods, the workpiece must be clamped several times for these different processing steps, which is generally done at a plurality of stations as well. In addition to having to maintain the plurality of stations, logistical steps are required as well and only orders of the same type may be carried out at the same time.

FIG. 2 shows a first embodiment of a combination of a machine tool 1 with a workpiece 25 which is fed by a robot arm 5. Since the robot arm 5 is very long and thus constitutes a large lever during the machining, a positioning unit 8 is provided for the exact positioning, which essentially consists of an outer sliding ring 15 mounted on a turntable 18 and an inner sliding ring 14, which is positioned therein in a concentrically sliding manner. The inner sliding ring 14 comprises a position sleeve 9 into which the robot arm 5 introduces an external holding apparatus 6, thus bringing the workpiece 25 in engagement with a grinding element 4 acting in the middle of the sliding rings 14, 15, said element being accommodated in an inner holding apparatus 3 of a machine tool 1.

To be able to show the different grinding positions according to FIG. 1, the turntable 18 may be rotated in its angle position about the second main axis of rotation 11 while, at the same time, the sliding rings 14 and 15 can be displaced relative to each other by a rotation of the inner sliding ring 14 with respect to the external sliding ring 15 about a first main axis of rotation 10 to change the azimuthal angle of the workpiece. To this purpose, the outer sliding ring comprises an elongated opening 16 to gain access to the position sleeve 9 in a plurality of positions.

Due to the fact that the machine tool 1 is arranged above a base 2, the positioning apparatus 8 above the turntable 18 and the robot arm, in this case directly on a shared table 7, the components are mutually arranged in the correct position. The positioning apparatus 8 always moves as the result of a movement of the robot arm 5 to the extent it moves in the direction of the permitted degrees of freedom. Movements outside the permitted degrees of freedom impair the positioning apparatus 8. As a result, the positioning apparatus 8 is purely a passive system which is fully controlled by the robot arm 5.

FIG. 3 shows the same arrangement once again from the opposite side, resulting in a view of the machine tool 1 and its base 2. The machine tool 1 protrudes so far into the inside of the concentric sliding rings 14 and 15 that the tool is arranged approximately in its middle. A rotation of the turntable 18 can only be performed until the sliding rings 14 and 15 come, in the extreme case, in contact with the machine tool 1 or its base 2, and a rotation of the inner sliding ring 14 can only be performed to the extent the position sleeve 9 remains in the opening 16 of the outer sliding ring 15.

FIG. 4 furthermore sides a cross-sectional view of the same arrangement, which shows, however, the inner configuration of the position sleeve 9. Said sleeve is accommodated in the inner sliding ring 14 and is pivotably mounted about an axis of rotation vertical to the drawing plane. Into the position sleeve 9, the robot arm 5 has introduced an external holding apparatus 6 into which a workpiece 25, which is not shown here, can be received and brought into engagement with the grinding element 4.

FIG. 5 shows an alternative embodiment of the positioning apparatus 8, which is not mounted on a turntable 18, but wherein the outer sliding ring 15 is firmly mounted on the table 7. The machine tool 1 with its spindle is vertically arranged in this case so that the grinding element 4 is aligned parallel with the table 7. The robot arm 5 is arranged such that it hangs from the ceiling, not shown.

Due to the fact that the machine tool passes through the sliding rings 14 and 15 from below, the inner sliding ring 14 also comprises an elongated opening so that the inner sliding ring 14 remains movable. Here as well, the position sleeve 9 is rotatably arranged above a first sleeve axis of rotation 12 so that a plurality of angle positions with respect to the grinding element 4 can be achieved. The inner sliding ring 14 and, with it, the position sleeve 9 can rotate about the first main axis of rotation 10, but a rotation about the second main axis of rotation 11 is not possible.

A further alternative is shown in FIG. 6. It is based on a carrier frame, which essentially consists of two guide tracks 21 as well as a slide 20, which can be moved in these guide tracks 21. The slide 20 essentially consists of a frame, which has the shape of an arch, is formed in the region of the guide tracks and accommodates a carrier ring 19 between two vertical rods. Said carrier ring can be moved up and down by means of a height adjustment 22 and also pivoted about a second sleeve axis of rotation 13. On its inside, the carrier ring 19 accommodates the position sleeve 9, which is rotatable about a first sleeve axis of rotation 10 with respect to the carrier ring 19 and thus about its own axis.

Due to these degrees of freedom, this alternative embodiment allows for a feed of an external holding apparatus 6 in a relative position to an inner holding apparatus 3 that is similar to the one in the aforementioned apparatuses. In this case as well, an actuation via a robot arm 5 or a portal solution is possible.

FIG. 7 shows a horizontally arranged machine tool 1, which comprises a grinding element 4 as a tool. Below the machine tool 1, a supporting table 23 is arranged, which may be connected to the base 2 shown in FIGS. 2 and 3, onto which the workpiece 25 may additionally be placed. Instead of coming to rest directly on the supporting table 23, it may also be introduced into a support sleeve 24 as shown in FIG. 7. The support sleeve 24 is height-adjustably fastened to the supporting table and may, in a further step, be displaced upward together with the workpiece 25, i.e., in engagement with the grinding element 4. This avoids any lateral slippage of pushing away.

What is therefore described above is an apparatus for positioning a workpiece and a tool with respect to one another, wherein the position of a feed apparatus is supported by a passive positioning apparatus and wherein a deviation from the specified degrees of freedom is prevented.

### LIST OF REFERENCE SIGNS

1 Machine tool
2 Base
3 Inner holding apparatus
4 Grinding element
5 Robot arm
6 External holding apparatus
7 Table
8 Positioning unit
9 Position sleeve
10 First main axis of rotation
11 Second main axis of rotation
12 First sleeve axis of rotation
13 Second sleeve axis of rotation
14 Inner sliding ring
15 External sliding ring
16 First opening
17 Second opening
18 Turntable
19 Carrier ring
20 Slide
21 Guide track
22 Height adjustment
23 Supporting table
24 Support sleeve
25 Workpiece

1. An apparatus for positioning a workpiece (25) and a tool with respect to one another, which are each held in a holding apparatus (3, 6), comprising an inner holding apparatus (3) arranged on a table (7) as well as an external holding apparatus (6) accommodated on a feed apparatus,
characterized in that the external holding apparatus (6) is supportingly held in a position sleeve (9) of a positioning unit (8) connected to the table (7), wherein the position sleeve (9) is rotatably mounted in the positioning unit (8) about a first main axis of rotation (10) about the inner holding apparatus (3).

2. The apparatus according to claim 1, characterized in that the position sleeve (9) is mounted about a first sleeve axis of rotation (12) such that it rotates about itself.

3. The apparatus according to claim 1, characterized in that the position sleeve (9) is held in a wall of an inner sliding ring (14), which is displaceably mounted vertically about the first main axis of rotation (10) in a concentric outer sliding ring (15), which is stationary with respect to the first axis of rotation (10) and rotatably with the inner sliding ring (14), with the outer sliding ring (15) comprising in the peripheral direction an elongated first opening (16) that keeps the position sleeve (9) free.

4. The apparatus according to claim 3, characterized in that the inner sliding ring (14) comprises an elongated second opening (17), wherein the inner holding apparatus (3) is held through the first opening (16) of the outer sliding ring (15), and the second opening (17) of the inner sliding ring (14) is held on the inside of the sliding rings (14, 15).

5. The apparatus according to claim 3, characterized in that the position sleeve (9) is rotatably mounted about a second main axis of rotation (11) about the inner holding apparatus (3).

6. The apparatus according to claim 5, characterized in that the sliding rings (14, 15) are arranged on a rotatable turntable (18) which is fixedly arranged on the table (7) and rotatable about the second main axis of rotation (11).

7. The apparatus according to claim 2, characterized in that the position sleeve (9) is rotatably mounted about a second sleeve axis of rotation (13) such that it rotates about itself.

8. The apparatus according to claim 7, characterized in that the position sleeve (9) is accommodated in a carrier ring (19) that is concentric to the position sleeve (9) such that it is rotatable about the first sleeve axis of rotation (12), with the carrier ring being accommodated on a slide (20) such that it is rotatably about the second sleeve axis of rotation (13), with the slide (20) being movable in at least one guide track (21) about the first main axis of rotation (10).

9. The apparatus according to claim 8, characterized in that the carrier ring (19) is mounted on the slide (20) such that it is height adjustable.

10. The apparatus according to claim 1, characterized in that the feed apparatus is a robot arm (5) by means of which the external holding apparatus (6) can be introduced into the position sleeve (9) and which furthermore drives the positioning unit (8) with its movements.

11. The apparatus according to claim 1, characterized in that the feed apparatus is a portal, which can move the external holding apparatus (6) in three dimensions, wherein the external holding apparatus (6) is furthermore mounted in the portal such that it can rotate about at least one axis of rotation, wherein, by means of the portal, the external holding apparatus (6) can be introduced into the position sleeve (9), and the portal furthermore drives the positioning unit (8) with its movements.

12. The apparatus according to claim 1, characterized in that the inner holding apparatus (3) holds the tool, and the external holding apparatus (6) feeds the workpiece (25).

13. The apparatus according to claim 12, characterized in that a supporting table (23) is arranged below the tool to support the workpiece (25) in engagement with the tool.

14. The apparatus according to claim 13, characterized in that a supporting sleeve (24) fastened to the supporting table (23) is assigned to the supporting table (23) such that the workpiece (25) can be introduced at least partially.

15. The apparatus according to claim 14, characterized in that the support sleeve (24) is fastened to the supporting table (23) such that it is height adjustable.

16. The apparatus according to claim 12, characterized in that the tool is a grinding element (4) or a milling element.

17. The apparatus according to claim 1, characterized in that the inner holding apparatus (3) holds the workpiece (25), and the external holding apparatus (6) feeds the tool.

18. The apparatus according to claim 17, characterized in that the tool comprises a tool laser.
